(19) United States
(12) Patent Application Publication
(10) Pub. No.: US 2001/0020464 A1
(43) Pub. Date: Sep. 13, 2001

(54) Arrangement for mounting a sparkplug of an internal combustion engine

(76) Inventors: Morito Asano, Osaka (JP); Atsushi Ito, Osaka (JP); Nariki Maeda, Osaka (JP); Teruji Ichihara, Osaka (JP); Yoshiyuki Fukumura, Osaka (JP); Mitsuhiro Izumi, Osaka (JP)

Correspondence Address: BANNER & WITCOFF, 1001 G STREET N W, SUITE 1100, WASHINGTON, DC, 20001, US

(21) Appl. No.: 09/783,022

(22) Filed: Feb. 15, 2001

(30) Foreign Application Priority Data
Mar. 7, 2000 (JP) P2000-061442

(51) Int. Cl. F02P 5/00

(52) U.S. Cl. 123/406.4

(57) ABSTRACT

The arrangement for mounting a sparkplug of an internal combustion engine in accordance with the present claimed invention is that the sparkplug is mounted so that all of the outside electrodes are arranged in areas of a side of an intake port opening and/or a side of an exhaust port opening limited by the sparkplug and the intake port opening and by the sparkplug and the exhaust port opening or in case at least one of the outside electrodes locates outside of the above-mentioned limited area, other remaining outside electrodes are arranged at positions to avoid facing the outside electrode locating outside of the limited area across the central electrode.

### BACKGROUND OF THE INVENTION AND

This invention relates to an arrangement for mounting a sparkplug of an internal combustion engine which is for detecting an ionic current flowing in a combustion chamber to detect an occurrence of knock or the like.

### RELATED ART STATEMENT

Conventionally, in an internal combustion engine for an automobile, an occurrence of knock or a limit of lean burn driving is judged by making use of an ionic current flowing in a combustion chamber immediately after ignited. The ionic current is detected by applying high voltage between a central electrode and an outside electrode of a sparkplug and detecting a current due to an electrical discharge with the central electrode and the outside electrode. In this case in order to obtain the ionic current positive voltage is applied to the central electrode of the sparkplug and negative voltage is applied to the outside electrode of the sparkplug. This is to detect a subtle ionic current accurately by charging the outside electrode with negative electricity so as to charge whole of the inner wall in the combustion chamber with negative electricity, which substantially increases an area of the electrode, which attracts a large amount of ions charged with positive electricity.

As a sparkplug for detecting an ionic current it is known, for example, that a surface area of a central electrode is made to be wider as mentioned in Japan patent laid open No.5-118266 or that a central electrode and an outside electrodes arranged around the central electrode are made to be longer than ordinaries as mentioned in Japan patent laid open No.9-317618 in order to improve an accuracy of detecting an ionic current.

As mentioned above, in case a central electrode and an outside electrode of a sparkplug are used as electrodes for detecting an ionic current, each of the electrodes suffers from abrasion due to an electrical discharge of high voltage. Then it is preferable to use a multi-pole sparkplug having a plurality of outside electrodes in order to improve resistance to abrasion. However, for two-pole sparkplug having two outside electrodes each facing across a central electrode as the center, an accuracy of detecting an occurrence of knock may be lowered depending on a direction of the outside electrode mounted-on a cylinder head when an occurrence of knock is detected based on an ionic current.

Generally, in driving after warming-up, temperature of the inner wall of the combustion chamber near an exhaust valve becomes high. When mixed air touches the inner wall of the combustion chamber at high temperature, the mixed air is ignited by itself due to the high temperature of the inner wall, resulting in an occurrence of knock. In inhaling and compressing air, the mixed air inhaled from an intake port passes near an exhaust port arranged to face the intake port, then passes an upper part of a piston and finally returns to the intake port again so as to circulate in a cylinder. Namely, the mixed air is introduced from an intake port along a ceiling of a combustion chamber, flows along an inner face of a cylinder facing the intake port, and then flows along an upper part of a piston and the inner face of the cylinder so as to circulate in a cylinder. Due to a flow of the mixed air, the mixed air in a side of the intake valve burns later than other portion when ignited, and pressure in the side of the intake valve also rises. Then the temperature of the mixed air rises while combustion is retarded, which makes a portion where combustion is retarded ignited by itself, resulting in an occurrence of knock. As mentioned above, when knock occurs, a pressure wave is generated in the combustion chamber. If a plurality of outside electrodes and the central electrode fall on a line in a direction at generally right angle with the pressure wave generated in case knock occurs, the outside electrodes disturb diffusion of the ionic current, which may disturb detecting the ionic current.

### OBJECT AND SUMMARY OF THE INVENTION

An object of this invention is to solve the above problems. In order to attain the object, this invention takes the following measures. In an arrangement for mounting a sparkplug of an internal combustion engine a sparkplug having a plurality of outside electrodes arranged to surround a central electrode is mounted so that the outside electrodes are arranged at positions to avoid a position generally at right angle with a direction to which a pressure wave travels or in case one of the outside electrodes is arranged at a position generally at right angle with a direction to which a pressure wave travels, other remaining outside electrodes are arranged at position to avoid a position facing each other across the central electrode.

This invention is an arrangement for mounting a sparkplug of an internal combustion engine wherein the arrangement is to detect an ionic current which flows after ignited in a combustion chamber of an internal combustion engine to which an intake port and an exhaust port open by the use of a sparkplug comprising a central electrode and a plurality of outside electrodes arranged spaced apart to surround the central electrode, characterized by that the sparkplug is mounted so that all of the outside electrodes are arranged in areas of a side of an intake port opening and/or a side of an exhaust port opening of areas limited by the sparkplug and the intake port opening and by the sparkplug and the exhaust port opening or in case at least one of the outside electrodes locates outside of the above-mentioned limited area, other remaining outside electrodes are arranged at positions to avoid facing the outside electrode locating outside of the limited area across the central electrode.

In accordance with the arrangement, the outside electrodes are not arranged facing each other across the central electrode in a direction at generally right angle with the pressure wave generated when knock occurs. In other words, knock occurs when abnormal combustion occurs due to self-ignition in the intake port and the exhaust port. The pressure wave generated by the abnormal combustion travels or diffuses from the intake port opening to the exhaust port opening or from the exhaust port opening to the intake port opening, in case the outside electrode and the central electrode are arranged in an limited area existing in a direction the pressure wave travels or they are arranged outside of the limited area, any of other remaining outside electrode does not locate at a position facing the outside electrode across the central electrode, thereby to suppress an influence of the pressure wave on the ionic current to a minimum. As a result, the ionic current can be detected with ease and an accuracy of detecting the ionic current can be improved, thereby to improve accuracy of detecting an occurrence of knock detected with a knock component added to the ionic current.

As a sparkplug having a plurality of outside electrodes, it is preferable that all of the outside electrodes are arranged at a position not to face each other across the central electrode. More concretely, it is represented by that three outside electrodes are arranged each spaced apart at an angle of 120 degrees around the central electrode as the center. In accordance with the arrangement of the outside electrodes, in case at least one of the outside electrode is arranged at the position to be avoided, there is no other outside electrode at a position facing the outside electrode across the central electrode, which makes it possible to position the outside electrodes with ease in mounting the sparkplug.

### BRIEF DESCRIPTION OF THE DRAWINGS

FIG. 1 is a magnified cross-sectional view showing a principal portion of an embodiment of the present claimed invention.

FIG. 2 is a front view of a sparkplug in accordance with the embodiment.

FIG. 3 is a view taken along line III-III in FIG. 1.

FIG. 4 is a bar graph showing a result of detecting an ionic current in accordance with the embodiment.

FIG. 5 is a bar graph showing a result of detecting an ionic current of an example for comparison to the result of the embodiment.

FIG. 6 is a view of the example for comparison which correspond to FIG. 3.

FIG. 7 is a view of another embodiment in accordance with the present claimed invention which corresponds to FIG. 3.

FIG. 8 is a view of a third embodiment in accordance with the present claimed invention which corresponds to FIG. 3.

FIG. 9 is a view of a forth embodiment in accordance with the present claimed invention which corresponds to FIG. 3.

### DETAILED DESCRIPTION OF THE PREFERRED EMBODIMENTS

An embodiment of the invention will be described in detail with reference to drawings.

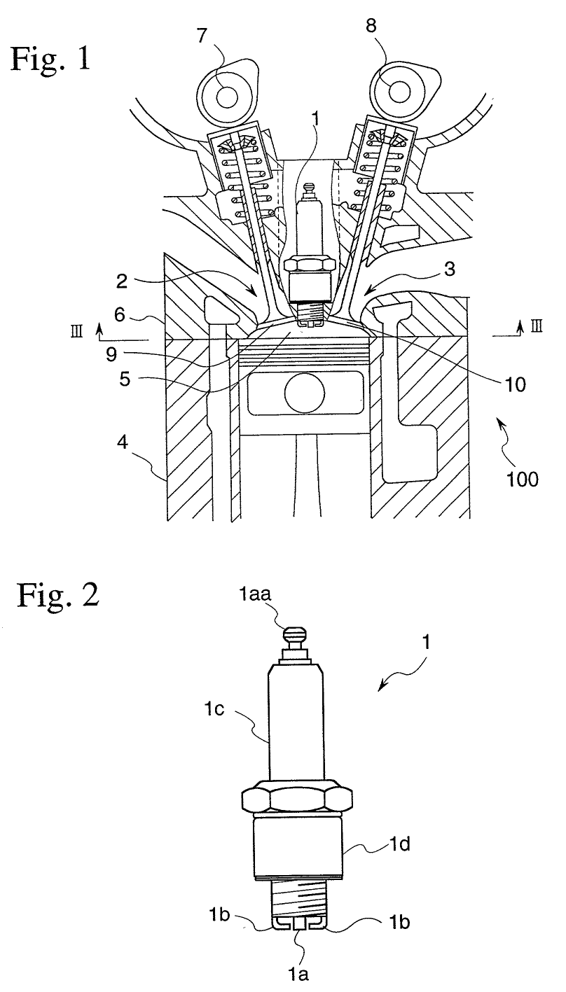

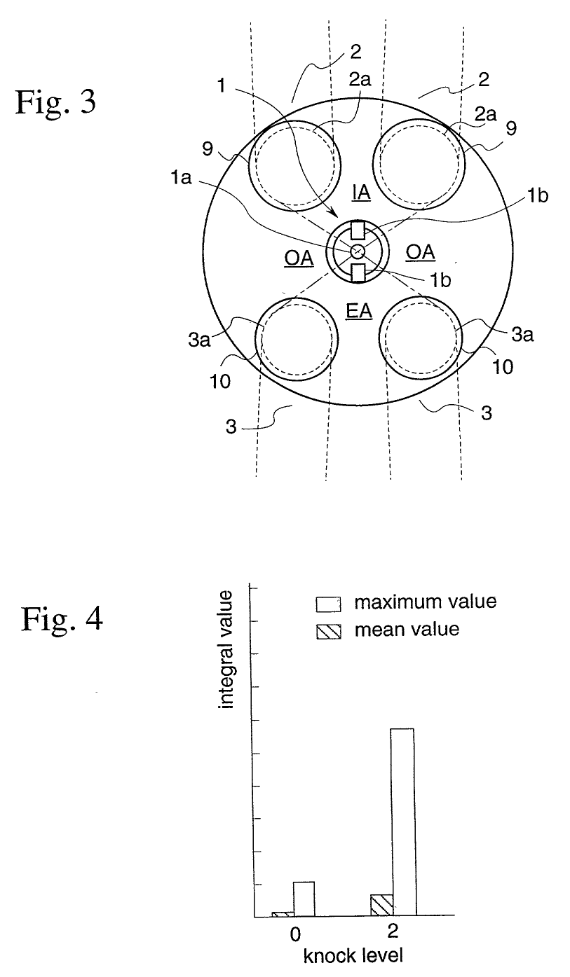

An engine EG as an internal combustion engine of which a portion where a sparkplug 1 is mounted is shown magnified in FIG. 1 is a type of DOHC, wherein an opening 2a of an intake port 2 and an opening 3a of an exhaust port 3 are arranged to face each other across the sparkplug 1 which is mounted on general center of a ceiling of a combustion chamber 5 as the center. The openings 2a and 3a are arranged at two portions respectively per a cylinder. (FIG. 3) More specifically, the engine EG is mounted on a cylinder block 4 and camshafts 7 and 8 are respectively mounted on an intake port side and an exhaust port side of a cylinder head 6 forming the ceiling of the combustion chamber 5. The intake port 2 of the cylinder head 6 is made to open or close by means of an intake valve 9 which makes a reciprocating motion due to rotation of the camshaft 7 and the exhaust port 3 is made to open or close by means of an exhaust valve 10 respectively. Between the intake port 2 and the exhaust port 3 mounted is the sparkplug 1 which also serves to detect an ionic current.

The sparkplug 1 of this embodiment is, as shown in FIG. 2, a double-pole sparkplug comprising a central electrode 1a and a plurality of, namely, two outside electrodes 1b. In other words, the sparkplug 1 is so arranged that the central electrode 1a passes through a center of the cylinder-shaped insulator 1c, a shell 1d made of metal fits over a lower half portion of the insulator 1c through a gasket which is not shown in drawings and two outside electrodes 1b are integrally arranged at positions facing each other across the center electrode 1a on a bottom face of the shell 1d. A top end of the center electrode 1a projects out of a top end of the insulator 1c, a terminal nut 1aa is formed at the top end of the center electrode 1a so a high-voltage cable which is not shown in drawings can be connected and a bottom end of the center electrode 1a projects by a predetermined length in a condition of being insulated out of a bottom end of a mounting external thread locating at a bottom end of the shell 1d. Each of the outside electrodes 1b is in a shape of an L character in side view wherein a side end face of a level portion of the outside electrode 1b faces to a circumferential face at the bottom end of the central electrode 1a and a bottom face of the level portion is set to have generally the same height as that of the bottom end of the central electrode 1a.

In accordance with the arrangement of the sparkplug 1, for detecting an ionic current which flows in the combustion chamber 5 of the engine EG after ignited by the use of the sparkplug 1 comprising the central electrode la and a plurality of outside electrodes 1b arranged spaced apart to surround the central electrode 1a, as shown in FIG. 3, the sparkplug 1 is mounted so that all of the outside electrodes 1b are arranged in areas of a side of the intake port 2 opening and/or a side of the exhaust port 3 opening of areas limited by the sparkplug 1 and the intake port 2 opening and by the sparkplug 1 and the exhaust port 3 opening or in case at least one of the outside electrodes 1b locates outside of the above-mentioned limited area, other remaining outside electrodes 1b are arranged at positions to avoid facing the outside electrode 1b locating outside of the limited area across the central electrode 1a. The area of the side of the intake port opening limited by the sparkplug 1 and the intake port 2 opening means an area which is surrounded by two segments (shown by imaginary lines in FIG. 3) between the center of the sparkplug 1 and the most separated surrounding lines near the openings 2a of the two intake ports 2 and which extends from the sparkplug 1 to the side of the intake port 2 and designates an intake port area IA shown in FIG. 3. Likewise, the area of the side of the exhaust port opening limited by the sparkplug 1 and the exhaust port 2 opening means an area which is surrounded by two segments (shown by imaginary lines in FIG. 3) between the center of the sparkplug 1 and the most separated surrounding lines near the openings 3a of the two exhaust ports 3 and which extends from the sparkplug 1 to the side of the exhaust port 3 and designates an exhaust port area EA shown in FIG. 3.

A relationship between a position of the outside electrode lb and the intake port area IA and the exhaust port area EA will now be explained with reference to FIG. 3. FIG. 3 is a schematically shown and magnified view of the ceiling portion of the combustion chamber 5 taken along line III-III in FIG. 1. In FIG. 3, the sparkplug 1 is so mounted that the outside electrodes lb locate in the intake port area IA and the exhaust port area EA divided by the imaginary lines in the FIG. 3 at the center as the sparkplug 1. As a result, in the double-pole sparkplug 1 having two outside electrodes lb like this embodiment all of the outside electrodes lb locate in the intake port area IA and the exhaust port area EA, namely, there is no outside electrode existing in a specified area OA which is between the intake port area IA and the exhaust port area EA. In mounting the sparkplug 1, tighten-the sparkplug 1 with a direction of a box wrench for tightening the sparkplug 1 coincided with a direction of the outside electrode 1b. This makes it possible to arrange the outside electrode 1b at a desired position just by watching a direction of the box wrench without checking a direction of the outside electrode 1b visually.

High voltage is applied to this sparkplug 1 with the central electrode la in positive and the outside electrodes lb in negative in order to detect an ionic current flowing in the combustion chamber 5 after ignited. An electrical discharge occurs between the central electrode la and the outside electrodes 1b when the high voltage is applied. The electrical discharge makes an ionic current flow through an H₃O⁺ ion which is contained in combustion gas. The ionic current is detected by the central electrode la and the outside electrodes lb including a cylinder inner wall. When knock occurs while detecting the ionic current, a pressure wave generated by the knock travels or diffuses from the intake port 2 side to the exhaust port 3 side or from the exhaust port 3 side to the intake port 2 side. A detecting efficiency changes depending on a position of the outside electrode lb relative to a diffusing condition of the ion because it is affected by the pressure wave. Then in case the outside electrode lb locates in the intake port area IA and the exhaust port area EA, a direction to which the pressure wave diffuses generally coincides with a direction in which the ionic current flows therefore a knock component which is added to the ionic current is conspicuously shown.

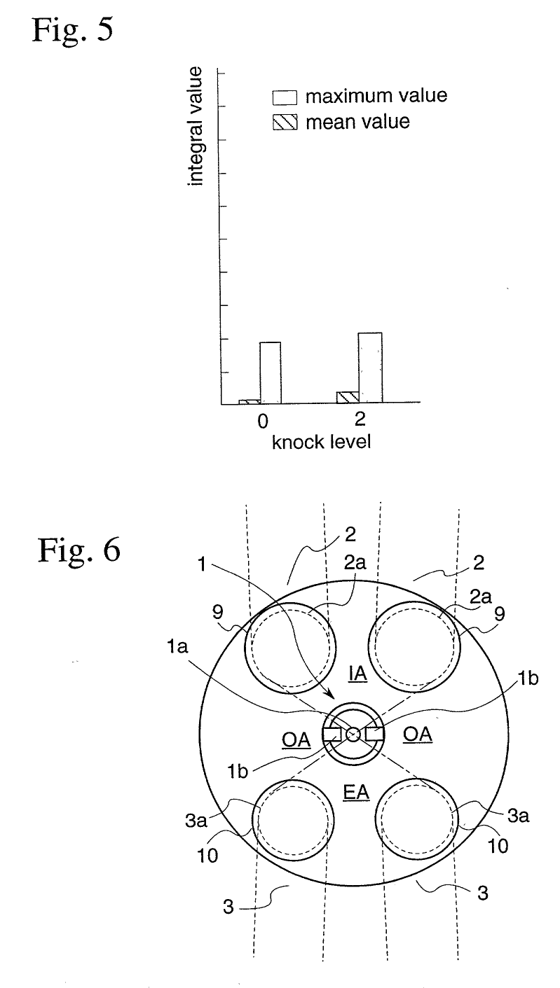

A bar graph shown in FIG. 4 is a result of detecting the ionic current in two cases while the engine EG is driven at middle speed, one of the cases is a knock level is 0 which means no knock occurs and another case is a knock level is 2 which means knock occurs. A bar graph shown in FIG. 5 is a result for comparison in which the outside electrode lb is arranged outside of the intake port area IA and the exhaust port area EA, namely, in the specified area OA between the intake port area IA and the exhaust port area EA as shown in FIG. 6.

To detect the knock component, a timing to ignite is advanced in angle until knock occurs which has a desired knock level, high voltage is applied between the center electrode 1a and the outside electrode 1b after ignition so as to flow an ionic current when knock occurs, the flowed ionic current is detected and a knock component (current having a knock frequency) which is added to the detected ionic current is detected. The knock level 0 means a detected current (due to noise) which is added to the ionic current and which is approximate to a knock component when no knock occurs. Generally, the higher the detected value (value of wave length) of the ionic current becomes, the bigger the knock component becomes. The ionic current is detected several times, for example, 100 times, and the knock component which is added to the detected ionic current is integrated and a mean value and the maximum value are shown in the bar graph. The above-explained result is a case that the engine EG is driven at middle speed, however, generally the same results were obtained in both cases at low and high speed.

As it is clear in the result, the embodiment wherein the outside electrodes lb are arranged in the intake port area IA and the exhaust port area EA shows the maximum value which is approximate three-times as much as that of an example for comparison and the mean value which is approximate twice as much as that of the example for comparison. In addition, since in this embodiment the result of the knock level 2 is approximate four times as much as that of the knock level 0 in the mean value and approximate five times in the maxim value, it is possible to detect an occurrence of knock with ease, thereby to improve an accuracy of detecting knock.

The invention is not limited to the above-described embodiment.

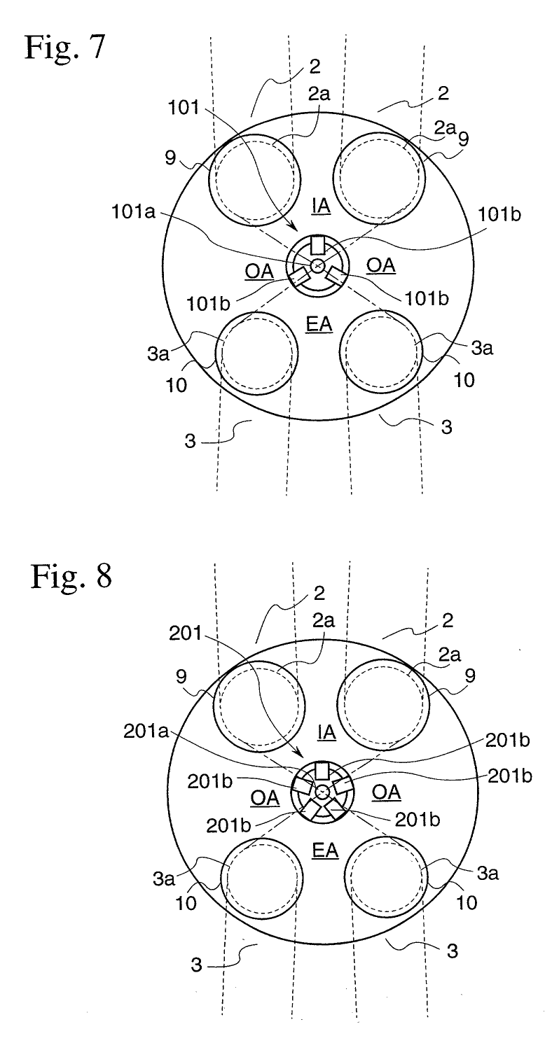

For example, as a sparkplug, a number of the outside electrode may be three, four or five. In case a sparkplug 101 having three outside electrodes 101b, as shown in FIG. 7, the outside electrodes 101b may be arranged each spaced apart at an angle of 120 degrees around the central electrode 101a as the center. For the sparkplug 101 of three-pole, one of the outside electrodes 101b is arranged, for example, in the intake port area IA and remaining two outside electrodes 101b are arranged extending over the specified area OA. In this case, since two outside electrodes 101b arranged extending over the specified area OA is separated at an angle of 120 degrees around the center, there is no chance of facing each other across the central electrode 101a. As a result, no outside electrode 101 is arranged at a position which is affected by a pressure wave when knock occurs. This makes it possible to detect the ionic current with ease, thereby to improve an accuracy of detecting knock.

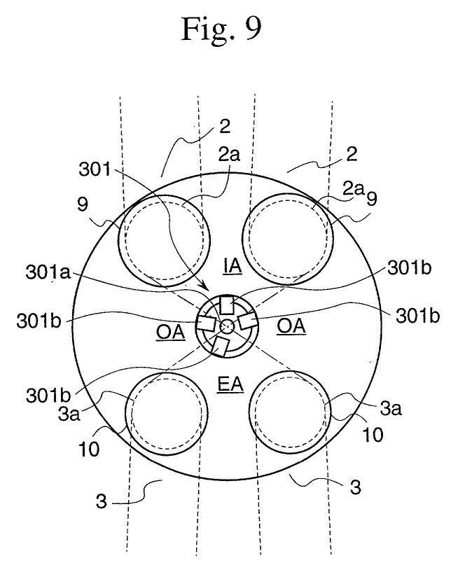

For a sparkplug 210 of five-pole, five outside electrodes 201b may be arranged each spaced apart at an angle of 72 degrees around a central electrode 201a as the center as shown in FIG. 8. For a sparkplug 301 having four outside electrodes 301b, as shown in FIG. 9, the outside electrodes 301b may be arranged each spaced apart not at equal intervals at right angles around a central electrode 301a but at non-equal intervals so that no outside electrode 301b is arranged at a position which faces to the outside electrode 301b locating outside of the intake port area IA and the exhaust port area EA across the central electrode 301a when some of the outside electrodes 301b locate outside of the intake port area IA and the exhaust port area EA. In accordance with the outside electrodes 301b arranged each spaced apart at non-equal intervals, when one of the outside electrodes 301b locates in the specified area OA between the intake port area IA and the exhaust port area EA, it can be avoided that other outside electrode 301b locates at a position facing the outside electrode 301b locating in the specified area OA across the central electrode 301a. As a result, this arrangement of the outside electrodes 301b does not deteriorate an accuracy of detecting an ionic current like the example for comparison.

For a sparkplug having two outside electrodes, the outside electrodes may be arranged to face each other across a central electrode unlike the above-explained arrangement. For a sparkplug of three-pole or of five-pole, outside electrodes may not be arranged each spaced apart at equal angles and may be arranged at a variety of different angles around a central electrode as the center. As mentioned above, the sparkplug may be arranged otherwise as far as the outside electrodes are not arranged to face each other across the central electrode, in other words, the sparkplug may be arranged in any form as far as the outside electrodes are not arranged spaced apart at an angle of 180 degrees. In accordance with the arrangement of the sparkplug, it becomes possible to position the outside electrodes with ease in mounting the sparkplug.

In the above-explained embodiment two intake ports and two exhaust ports are arranged to open respectively, but a number of an intake port opening and an exhaust port opening is not limited to two and each of the number may be one. In addition, one exhaust port opening may be arranged to two intake port openings.

An arrangement of other components is not limited to the drawings of the above-mentioned embodiment, and there may be various modifications without departing from the spirit and essential characteristics thereof.

As mentioned above, in accordance with the invention, since the sparkplug is mounted so that all of the outside electrodes are arranged in the areas of a side of the intake port opening and/or a side of the exhaust port opening of areas limited by the sparkplug and the intake port opening and by the sparkplug and the exhaust port opening or in case at least one of the outside electrodes locates outside of the above-mentioned limited areas, other remaining outside electrodes are arranged at positions to avoid facing the outside electrode locating outside of the limited area across the central electrode, there is no chance of any outside electrodes facing each other across the central electrode in a direction at generally right angle with a pressure wave generated in case knock occurs, thereby to suppress an effect of the pressure wave on the ionic current to a minimum when the ionic current flows. As a result, ions diffuse effectively, which makes it possible to detect the ionic current with ease, thereby to detect an occurrence of knock precisely based on the knock component added to the ionic current.

As a sparkplug having a plurality of outside electrodes, if all of the outside electrodes are arranged across a central electrode at positions where any of the outside electrodes do not face each other, no outside electrode is arranged at a position to face each other across the central electrode even though at least one of the outside electrodes is arranged in a position to avoid arranging the outside electrodes. As a result, it becomes possible to position the outside electrodes with ease.

1. An arrangement for mounting a sparkplug of an internal combustion engine wherein the arrangement is to detect an ionic current which flows after ignited in a combustion chamber of an internal combustion engine to which an intake port and an exhaust port open by the use of a sparkplug comprising a central electrode and a plurality of outside electrodes arranged spaced apart to surround the central electrode,
characterized by that the sparkplug is mounted so that all of the outside electrodes are arranged in areas of a side of an intake port opening and/or a side of an exhaust port opening of areas limited by the sparkplug and the intake port opening and by the sparkplug and the exhaust port opening or in case at least one of the outside electrodes locates outside of the above-mentioned limited area, other remaining outside electrodes are arranged at positions to avoid facing the outside electrode locating outside of the limited area across the central electrode.

2. The arrangement for mounting a sparkplug of an internal combustion engine, described in claim 1 and characterized by that the sparkplug is used wherein all of the outside electrodes are arranged at a position to avoid facing each other across the central electrode.

3. The arrangement for mounting a sparkplug of an internal combustion engine, described in claim 1 and characterized by that the sparkplug is used wherein three outside electrodes are arranged each spaced apart at an angle of 120 degrees around the central electrode as the center.
